(19) United States
(12) Patent Application Publication
(10) Pub. No.: US 2015/0024269 A1
(43) Pub. Date: Jan. 22, 2015

(54) SULFATE ELECTRODES

(71) Applicant: FARADION LTD., Sheffield (GB)

(72) Inventor: Jeremy Barker, Oxfordshire (GB)

(21) Appl. No.: 14/375,494

(22) PCT Filed: Jan. 30, 2013
(86) PCT No.: PCT/GB2013/050198

§ 371 Date: Jul. 30, 2014

(30) Foreign Application Priority Data
Feb. 1, 2012 (GB) 1201717.4

(51) Int. Cl. H01M 4/58; H01M 10/0525; H01M 10/054; H01M 4/136; H01M 10/36

(52) U.S. Cl. CPC H01M 4/581; H01M 4/136; H01M 10/36; H01M 10/054; H01M 10/0525
USPC 429/219; 429/231.9; 429/231.95; 429/224; 429/221; 429/223; 429/220; 429/231.6

(57) ABSTRACT

The invention relates to electrodes that contain active materials of the formula: AₐM_{b}(SO₄)_{c}Xₓ wherein A is a single or mixed alkali metal phase comprising one or more of sodium, potassium, lithium mixed with sodium, lithium mixed with potassium or lithium mixed with sodium and potassium; M is selected from one or more transition metals and/or non-transition metals and/or metalloids; X is a moiety comprising one or more atoms selected from halogen and OH; and further wherein 1<a<3; b is in the range: 0<b≦2; c is in the range: 2≦c≦3 and x is in the range 0≦x≦1. Such electrodes are useful in, for example, sodium ion battery applications.

### FIELD OF THE INVENTION

The present invention relates to electrodes that contain an active material comprising a sulfate group, and to the use of such electrodes, for example in sodium ion battery applications. The invention also relates to certain novel materials and to the use of these materials, for example as an electrode material.

### BACKGROUND OF THE INVENTION

Sodium-ion batteries are analogous in many ways to the lithium-ion batteries that are in common use today; they are both reusable secondary batteries that comprise an anode (negative electrode), a cathode (positive electrode) and an electrolyte material, both are capable of storing power in a compact system by accumulating energy in the chemical bonds of the cathode, and they both charge and discharge via a similar reaction mechanism. When a sodium-ion (or lithium-ion battery) is charging, Na⁺ (or Li⁺) ions de-intercalate from the cathode and migrate towards the anode. Meanwhile charge balancing electrons pass from the cathode through the external circuit containing the charger and into the anode of the battery. During discharge the same process occurs but in the opposite direction.

Lithium-ion battery technology has enjoyed a lot of attention in recent years and provides the preferred portable battery for most electronic devices in use today; however lithium is not a cheap metal to source and is too expensive for use in large scale applications. By contrast sodium-ion battery technology is still in its relative infancy but is seen as advantageous; sodium is much more abundant than lithium and researchers predict this will provide a cheaper and more durable way to store energy into the future, particularly for large scale applications such as storing energy on the electrical grid. Nevertheless a lot of work has yet to be done before sodium-ion batteries are a commercial reality.

From the prior art, it is known, for example from patent application WO2011078197, to prepare sodium-ion batteries containing an electrode active material comprising a mixture of a transition metal sodium phosphate and a powder of a composite metal oxide. Similarly, EP2239805 discloses electrodes comprising sodium mixed transition metal oxides, and U.S. Pat. No. 6,872,492 teaches a sodium-ion battery comprising an electrode active material comprising AₐM_{b}(XY₄)_{c}Z_{d} where A is sodium, M is one or more metals comprising one metal capable of undergoing oxidation to a higher valance state, XY₄ is a phosphate or similar group and z is OH or halogen. Further prior art includes EP0743692 which teaches positive electrode materials of the formula: LiₓFe₂(SO₄)₃ where 0<x<2, and U.S. Pat. No. 5,908,716 which discloses compounds of the formula: AₓM_{y}(SO₄)_{z}, and specifically discloses compounds where x=3 and z=3, and where x=1 and z=2.

In a first aspect, the present invention aims to provide a cost effective electrode that contains an active material that is straightforward to manufacture and easy to handle and store. A further object of the present invention is to provide an electrode that has a high initial charge capacity and which is capable of being recharged multiple times without significant loss in charge capacity.

Therefore, the present invention provides an electrode containing an active material of the formula:

AₐM_{b}(SO₄)_{c}Xₓ
wherein
A is a single or mixed alkali metal phase comprising one or more of sodium, potassium, lithium mixed with sodium, lithium mixed with potassium, and lithium mixed with both sodium and potassium;
M is selected from one or more transition metals and/or non-transition metals and/or metalloids;
X is a moiety comprising one or more atoms selected from halogen and OH; and further wherein
1<a<3; b is in the range: 0<b≦2; c is in the range: 2≦c≦3 and x is in the range 0≦x≦1.

In one embodiment of the above formula, one or more of a, b, c and x are integers i.e. whole numbers. An embodiment where a=2 is preferred. In an alternative embodiment one or more of a, b, c and x are non-integers, i,e, fractions.

In another preferred embodiment, the present invention is directed to an electrode that contains an active material of the formula:

AₐM_{b}(SO₄)_{c}Xₓ
wherein
A is selected from one or more of alkali metals;
M is selected from one or more transition metals and/or non-transition metals and/or metalloids;
X is a moiety comprising one or more atoms selected from halogen and OH and further wherein
a=2; b=1 or 2; c=2 or 3 and x=0 or 1.

In particular, the present invention provides an electrode as described above in which the active material comprises one or more transition metals and/or non-transition metals and/or metalloids (M) selected from titanium, vanadium, niobium, tantalum, hafnium, chromium, molybdenum, tungsten, manganese, iron, osmium, cobalt, nickel, palladium, platinum, copper, silver, gold, zinc, cadmium, aluminium, scandium, yttrium, zirconium, technetium, rhenium, ruthenium, rhodium, iridium, mercury, gallium, indium, tin, lead, bismuth and selenium, magnesium, calcium, beryllium, strontium, barium, boron, silicon, germanium, arsenic, antimony and tellurium;

The moiety X preferably comprises one or more atoms selected from fluorine, chlorine, bromine, iodine and hydroxide.

In a preferred electrode of the present invention, M comprises one or more elements selected from nickel, cobalt, manganese and iron.

In a preferred electrode of the present invention the molar ratio of a:b:c is 1:1:1.5. Examples of suitable compounds include those with the general formula: A₂M₂(SO₄)₃

In another preferred electrode of the present invention the molar ratio of a:b:c is 1:0.5:1. Examples of suitable compounds include those with the general formula: A₂M(SO-₄)₂.

Other preferred materials of the present invention include: Na₂M(SO₄)₂ and Na₂M₂(SO₄)₃ such as Na₂Fe(SO₄)₂, Na₂Fe₂(SO₄)₃, Na₂Mn(SO₄)₂ and Na₂Mn₂(SO₄)₃.

Electrodes according to the present invention are suitable for use in many different applications, for example energy storage devices, rechargeable batteries, electrochemical devices and electrochromic devices. Advantageously, the electrodes according to the invention are used in conjunction with a counter electrode and one or more electrolyte materials. The electrolyte materials may be any conventional or known materials and may comprise either aqueous electrolyte(s) or non-aqueous electrolyte(s) or mixtures thereof.

The active materials of the present invention may be prepared using any known and/or convenient method. For example, using a solution reaction using an aqueous or other solvent. However ideally, the starting materials are intimately admixed in particulate form. This can be achieved using various methods, for example by finely grinding the materials separately using a pestle and mortar or a ball mill, and then mixing them together, or the materials can be admixed whilst they are being finely ground. The grinding and admixing is of sufficient duration to produce a uniformly intermixed and finely ground powder. A solvent such as acetone or another material which is easily removed, for example a low boiling liquid, can be used to assist the grinding/admixing process and this is preferably removed prior to a heating step. Other known techniques such as high energy ball milling and microwave activation may also be used to help prepare the starting materials, for example to increase their reactivity.

Some reactions, notably some solution reactions, proceed at room temperature. However typically the active materials are made by heating the precursor materials, for example in a furnace. This is especially useful when the reaction is a solid state reaction process, i.e. a reaction in which all of the reactants are in solid form and are substantially free of any reaction medium such as a solvent. Where a solvent or other low boiling liquid is used to assist the mixing of the reactants, as described above, it is substantially removed prior to the heating step.

The heating step typically involves heating the reaction mixture either at a single temperature, or over a range of temperatures, for example up to at least 25° C., preferably up to at least 50° C., further preferably up to at least 150° C., and yet further preferably up to 600° C., although for some reactants a single or a range of reaction temperatures up to 1200° C. may be needed. Conveniently the reaction is performed under atmospheric pressure and under a non-oxidising atmosphere, for example nitrogen, argon or another inert gas, or under vacuum. Depending on the target material and the precursors used, the reaction may also be performed in a sealed reaction vessel. Advantageously, the reaction temperature is maintained for between 0.5 and 12 hours, although the exact time will depend on the reactivity of the starting materials. A dwell time of 8 hours has been found to be sufficient for many reactions.

The conversion of a sodium-ion rich material to a lithium-ion rich material may be effected using an ion exchange process.

Typical ways to achieve Na to Li ion exchange include:
1. Mixing the sodium-ion rich material with an excess of a lithium-ion material e.g. LiNO₃, heating to above the melting point of LiNO₃ (264° C.), cooling and then washing to remove the excess LiNO₃;
2. Treating the Na-ion rich material with an aqueous solution of lithium salts, for example 1M LiCl in water; and
3. Treating the Na-ion rich material with a non-aqueous solution of lithium salts, for example LiBr in one or more aliphatic alcohols such as hexanol, propanol etc.

In a further aspect, the present invention provides an energy storage device comprising an electrode as described above, for use as one or more of the following: a sodium ion and/or lithium ion and/or potassium ion cell; a sodium metal and/or lithium metal and/or potassium metal ion cell; a non-aqueous electrolyte sodium ion and/or lithium ion and/or potassium ion cell; and an aqueous electrolyte sodium ion and/or lithium ion and/or potassium ion cell. Specifically, the energy storage device may be a battery.

### BRIEF DESCRIPTION OF THE DRAWINGS

The present invention will now be described with reference to the following drawings in which:

FIG. 1A is the XRD of Na₂Fe(SO₄)₂ (X0176) prepared according to Example 1;

FIG. 1B shows the constant current cycling (Electrode Potential versus Cumulative Specific Capacity of Na₂Fe(SO₄)₂(X0176) (Example 1);

FIG. 1C shows the constant current cycling (Discharge Specific Capacity versus Cycle Number) of Na₂Fe(SO₄)₂ (X0176) (Example 1);

FIG. 2A is the XRD for Na₂Fe(SO₄)₂ (X0126) prepared according to Example 2;

FIG. 2B shows the results from EVS testing, Electrode Potential (vs lithium) vs Cathode Specific Potential of Na₂Fe(SO₄)₂ (X0126) (Example 2);

FIG. 2C shows the first cycle data for Differential Capacity versus Electrode Potential for Na₂Fe(SO₄)₂ (X0126) (Example 2);

FIG. 3A is the XRD for Na₂Fe(SO₄)₂ (X0182) prepared according to Example 3;

FIG. 3B shows the constant current cycling (Electrode Potential vs Cumulative Specific Capacity) of Na₂Fe(SO₄)₂ (X0182) (Example 3);

FIG. 3C shows constant current cycling (Discharge Specific Capacity vs Cycle Number) of Na₂Fe(SO₄)₂ (X0182) (Example 3);

FIG. 4A is the XRD for Na₂Fe(SO₄)₂ (X0224) prepared according to Example 4;

FIG. 4B shows the constant current cycling (Electrode Potential vs Cumulative Specific Capacity) of Na₂Fe(SO₄)₂ (X0224) (Example 4);

FIG. 4C shows constant current cycling (Discharge Specific Capacity vs Cycle Number) of Na₂Fe(SO₄)₂ (X0224) (Example 4);

FIG. 5A is the XRD of Na₂Fe(SO₄)₂ (X0960) prepared according to Example 5;

FIG. 5B shows constant current cycling (Electrode Potential (vs sodium reference) vs Cumulative Specific Capacity of Na₂Fe(SO₄)₂ (X0960) (Example 5);

FIG. 5C shows constant current cycling (Differential Capacity vs Electrode Potential (vs sodium reference) of Na₂Fe(SO₄)₂ (X0960) (Example 5);

FIG. 6A the XRD of Na₂Fe(SO₄)₂ (X0968) prepared according to Example 6;

FIG. 6B shows constant current cycling (Electrode Potential (vs sodium reference) vs Cumulative Specific Capacity of Na₂Fe(SO₄)₂ (X0968) (Example 6);

FIG. 6C shows constant current cycling (Differential Capacity vs Electrode Potential (vs sodium reference) of Na₂Fe(SO₄)₂ (X0968) (Example 6);

FIG. 7A shows the XRD of Na₂Fe(SO₄)₂ (X0985) prepared according to Example 7;

FIG. 7B shows constant current cycling (Electrode Potential (vs sodium reference) vs Cumulative Specific Capacity of Na₂Fe(SO₄)₂ (X0985) (Example 7);

FIG. 7C shows constant current cycling (Differential Capacity vs Electrode Potential (vs sodium reference) of Na₂Fe(SO₄)₂ (X0985) (Example 7);

### DETAILED DESCRIPTION

Active materials used in the present invention are prepared on a laboratory scale using the following generic method:

Generic Synthesis Method:

The required amounts of the precursor materials are intimately mixed together. The resulting mixture is then heated in a tube furnace or a chamber furnace using either a flowing inert atmosphere (e.g. argon or nitrogen) or an ambient air atmosphere, at a furnace temperature of at least 50° C. until reaction product forms. When cool, the reaction product is removed from the furnace and ground into a powder.

Using the above method, active materials used in the present invention were prepared in Examples 1 to 7 summarised below in Table 1.

TABLE 1

| | TARGET | | | |
|---|---|---|---|---|
| EX- | COMPOUND | STARTING | SPECIAL MIXING | FURNACE |
| AMPLE | (ID code) | MATERIALS | CONDITIONS | CONDITIONS |
| 1 | Na₂Fe(SO₄)₂ | 0.48 g Na₂CO₃ | The starting materials | N₂ |
| | (X0176) | 2.20 g Fe₂(SO₄)₃•5H₂O | were intimately mixed | 5° C./minute, up |
| | XRD scan | 0.13 g Carbon | using a pestle and | to 430° C., dwell |
| | parameters: | Malt vinegar | mortar, then steeped in | time of 8 hours. |
| | Cu Kα (1.5418 \acute{Å}) | | malt vinegar and left to | |
| | 2θ = 5°-60° | | dry for 72 hours before | |
| | Increment: | | heating in a furnace | |
| | 0.015°/step | | | |
| | Speed: 0.5 secs/step | | | |
| 2 | Na₂Fe(SO₄)₂ | 0.48 g Na₂CO₃ | Starting materials were | N₂ |
| | (X0126) | 4.33 g | hand-mixed | 5° C./minute, up |
| | XRD scan | NH₄Fe(SO₄)₂•12H₂O | | to 450° C., dwell |
| | parameters: | 0.13 g Carbon | | time of 8 hours. |
| | Cu Kα (1.5418 \acute{Å}) | | | |
| | 2θ = 5°-60° | | | |
| | Increment: | | | |
| | 0.015°/step | | | |
| | Speed: 1.0 secs/step | | | |
| 3 | Na₂Fe(SO₄)₂ | 1.45 g Na₂SO₄ | Starting materials were | N₂ |
| | (X0182) | 2.84 g FeSO₄•7H₂O | hand-mixed | 5° C./minute, up |
| | XRD scan | | | to 430° C., dwell |
| | parameters: | | | time of 8 hours. |
| | Cu Kα (1.5418 \acute{Å}) | | | |
| | 2θ = 5°-60° | | | |
| | Increment: | | | |
| | 0.015°/step | | | |
| | Speed: 0.5 secs/step | | | |
| 4 | Na₂Fe(SO₄)₂ | 1.45 g Na₂SO₄ | Starting materials were | N₂ |
| | (X0224) | 2.84 g FeSO₄•7H₂O | mix homogenised in a | 5° C./minute, up |
| | XRD scan | 0.15 g Carbon | microniser and then | to 400° C., dwell |
| | parameters: | | heated to melting point | time of 8 hours. |
| | Cu Kα (1.5418 \acute{Å}) | | | |
| | 2θ = 5°-60° | | | |
| | Increment: | | | |
| | 0.015°/step | | | |
| | Speed: 0.5 secs/step | | | |
| 5 | Na₂Fe(SO₄)₂ | 0.48 g Na₂CO₃ | Starting materials were | N₂ |
| | (X0960) | 2.20 g Fe₂(SO₄)₃•H₂O | homogenised in a | 5° C./minute up |
| | XRD scan | 0.16 g Sucrose | microniser, using 5 g | to 340° C., dwell |
| | parameters: | | acetone | time 8 hours |
| | Cu Kα (1.5418 \acute{Å}) | | | |
| | 2θ = 5°-60° | | | |
| | Increment: | | | |
| | 0.025°/step | | | |
| | Speed: 1.0 secs/step | | | |
| 6 | Na₂Fe(SO₄)₂ | 0.18 g Na₂CO₃ | Starting materials were | N₂ |
| | (X0968) | 0.24 g Na₂SO₄ | homogenised in a | 5° C./minute up to |
| | XRD scan | 0.68 g Fe₂(SO₄)₃ | microniser, using 5 g | 340° C., dwell |
| | parameters: | 0.06 g Sucrose | acetone | time 8 hours |
| | Cu Kα (1.5418 \acute{Å}) | | | |
| | 2θ = 5°-60° | | | |
| | Increment: | | | |
| | 0.025°/step | | | |
| | Speed: 1.0 secs/step | | | |
| 7 | Na₂Fe(SO₄)₂ | 0.48 g Na₂CO₃ | Starting materials were | N₂ |
| | (X0985) | 1.25 g FeSO₄•7H₂O | mixed by hand in a | 5° C./minute up |
| | XRD scan | 2.16 g | pestle and mortar using | to 340° C., dwell |
| | parameters: | NH₄Fe(SO₄)₂•12H₂O | 5 g deionised water | time 8 hours |
| | Cu Kα (1.5418 \acute{Å}) | 0.08 g Sucrose | | |
| | 2θ = 5°-60° | | | |
| | Increment: | | | |
| | 0.025°/step | | | |
| | Speed: 1.0 secs/step | | | |

Product Analysis Using XRD

All of the product materials were analysed by X-ray diffraction techniques using a Siemens D5000 powder diffractometer to confirm that the desired target materials had been prepared and to establish the phase purity of the product material and to determine the types of impurities present. From this information it is possible to determine the unit cell lattice parameters.

Electrochemical Results

The target materials were tested in lithium or sodium metal anode test electrochemical cells to determine their specific capacity and also to establish whether they have the potential to undergo charge and discharge cycles. These test electrochemical cells containing the active material are constructed as follows:

Generic Procedure to Make a Lithium Metal Test Electrochemical Cell

The positive electrode is prepared by solvent-casting a slurry of the active material, conductive carbon, binder and solvent. The conductive carbon used is Super P (Timcal). PVdF co-polymer (e.g. Kynar Flex 2801, Elf Atochem Inc.) is used as the binder, and acetone is employed as the solvent. The slurry is then cast onto glass and a free-standing electrode film is formed as the solvent evaporates. The electrode is then dried further at about 80° C. The electrode film contains the following components, expressed in percent by weight: 80% active material, 8% Super P carbon, and 12% Kynar 2801 binder. Optionally, an aluminium current collector may be used to contact the positive electrode. Metallic lithium on a copper current collector may be employed as the negative electrode. The electrolyte comprises one of the following: (i) a 1 M solution of LiPF₆ in ethylene carbonate (EC) and dimethyl carbonate (DMC) in a weight ratio of 1:1; (ii) a 1 M solution of LiPF₆ in ethylene carbonate (EC) and diethyl carbonate (DEC) in a weight ratio of 1:1; or (iii) a 1 M solution of LiPF₆ in propylene carbonate (PC) A glass fibre separator (Whatman, GF/A) or a porous polypropylene separator (e.g. Celgard 2400) wetted by the electrolyte is interposed between the positive and negative electrodes.

Generic Procedure to Make a Sodium Metal Test Electrochemical Cell

The positive electrode is prepared by solvent-casting a slurry of the active material, conductive carbon, binder and solvent. The conductive carbon used is Super P (Timcal). PVdF co-polymer (e.g. Kynar Flex 2801, Elf Atochem Inc.) is used as the binder, and acetone is employed as the solvent. The slurry is then cast onto glass and a free-standing electrode film is formed as the solvent evaporates. The electrode is then dried further at about 80° C. The electrode film contains the following components, expressed in percent by weight: 80% active material, 8% Super P carbon, and 12% Kynar 2801 binder. Optionally, an aluminium current collector may be used to contact the positive electrode. Metallic sodium on a stainless steel or copper current collector may be employed as the negative electrode. The electrolyte comprises a 0.5 M solution of NaClO₄ in propylene carbonate (PC). A glass fibre separator (Whatman, GF/A) or a porous polypropylene separator wetted by the electrolyte is interposed between the positive and negative electrodes.

Cell Testing

The cells are tested in one of two ways:
Constant Current Cycling. The cell is cycled at a given current density between pre-set voltage limits. A commercial battery cycler from Maccor Inc. (Tulsa, Okla., USA) is used. On charge, sodium (lithium) ions are extracted from the active material. During discharge, sodium (lithium) ions are re-inserted into the active material.
(ii) Electrochemical Voltage Spectroscopy (EVS). High-resolution electrochemical measurements are performed using the (EVS) technique. EVS is a voltage step method, which provides a high-resolution approximation to the open circuit voltage curve for the electrochemical system under investigation. The differential capacity data have been demonstrated to allow effective characterization of order-disorder and structural ordering phenomenon in intercalation systems. The EVS method is roughly equivalent to a C/20 rate for charge and discharge.

### ELECTROCHEMICAL RESULTS

### ELECTROCHEMICAL RESULTS FOR ACTIVE MATERIAL MADE BY EXAMPLE 1

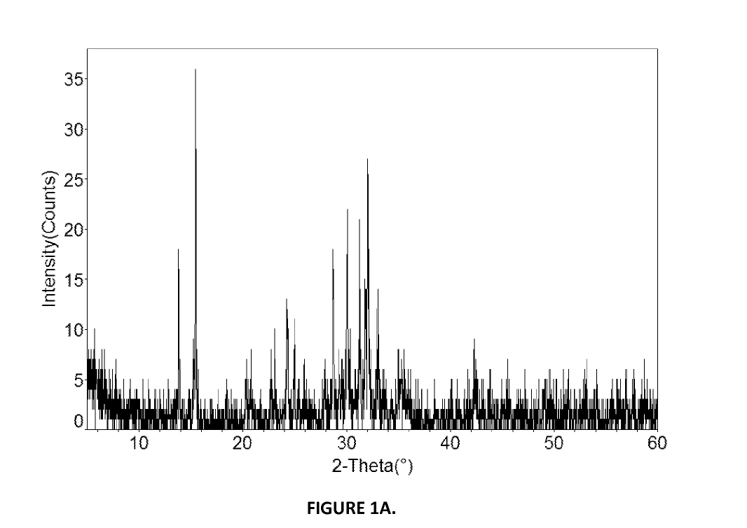

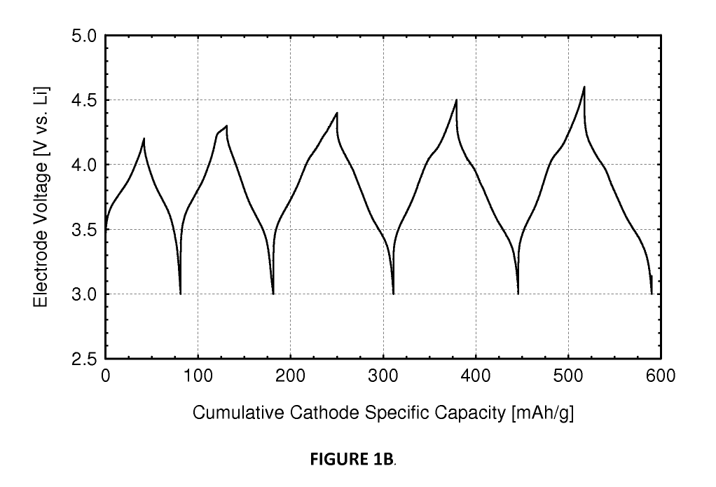

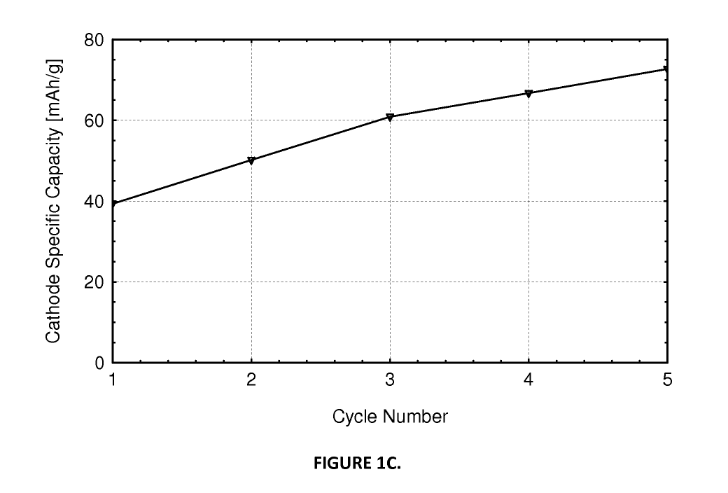

Referring to FIG. 1B. The Cell #112032 shows the constant current cycling data for the Na₂Fe(SO₄)₂ active material (X0176) prepared in accordance with Example 1 described above. The Open Circuit Voltage (OCV) of the as-made cell was 3.37 V vs. Li. The constant current data were collected using a lithium metal counter electrode at an approximate current density of 0.01 mA/cm² between voltage limits of 1.00 and 4.20 V. The upper voltage limit was increased by 0.1 V on subsequent cycles. The testing was carried out at room temperature. It is shown that sodium ions are extracted from the active material during the initial charging of the cell. A charge equivalent to a material specific capacity of 42 mAh/g is extracted from the active material.

It is expected from thermodynamic considerations that the sodium extracted from the Na₂Fe(SO₄)₂ active material during the initial charging process, enters the electrolyte, and would then be displacement ‘plated’ onto the lithium metal anode (i.e. releasing more lithium into the electrolyte). Therefore, during the subsequent discharging of the cell, it is assumed that a mix of lithium and sodium ions are re-inserted into the active material. The re-insertion process corresponds to 40 mAh/g, indicating the reversibility of the ion extraction-insertion processes. The generally symmetrical nature of the charge-discharge curves further indicates the excellent reversibility of the system.

Subsequent cycling of the cell indicates the reversibility of the ion extraction-insertion reactions. As the upper voltage limit is increased it is possible to access more and more of the sodium ions within the Na₂Fe(SO₄)₂ structure. Within the voltage range 3.0 to 4.6 V vs. Li, a reversible discharge specific capacity of 72 mAh/g is achieved, as illustrated in FIG. 1c. In addition, the level of voltage hysteresis (i.e. the voltage difference between the charge and discharge processes) is extremely small, indicating the excellent kinetics of the extraction-insertion reactions. This is an important property that is useful for producing a high rate active material.

### ELECTROCHEMICAL RESULTS FOR THE ACTIVE MATERIAL MADE BY EXAMPLE 2

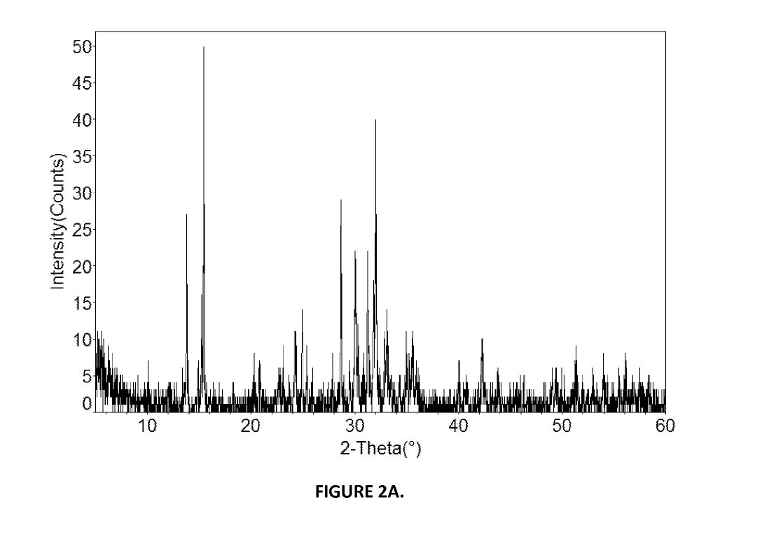

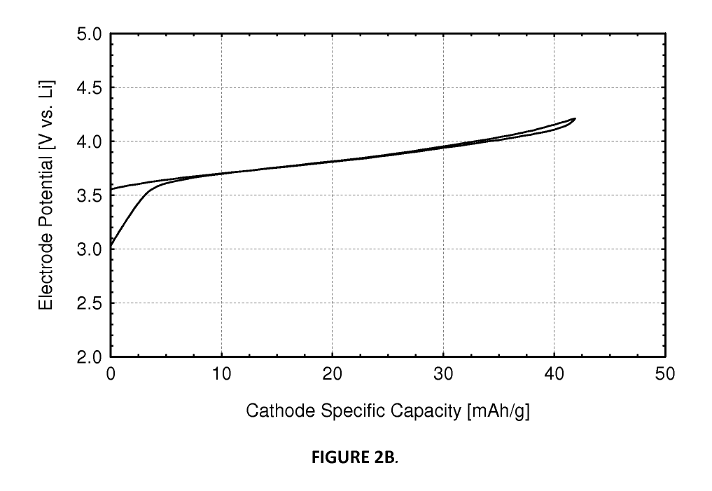

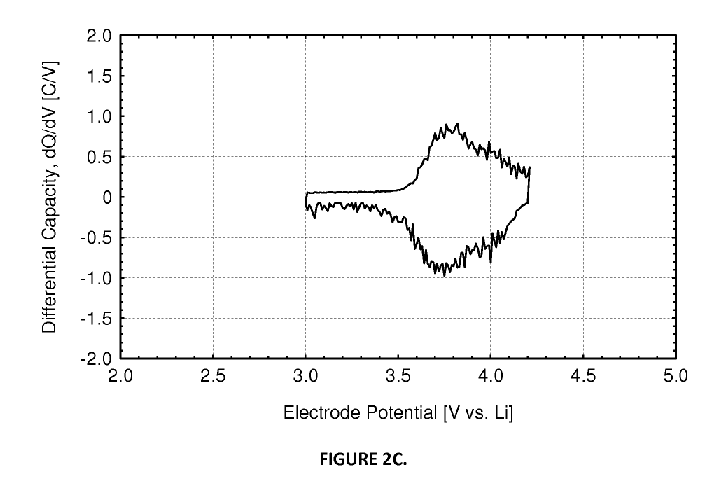

FIG. 2B (Cell #111066) for Na₂Fe(SO₄)₂ (X0126) made in Example 2 above, shows the first cycle EVS testing for this material. The charge (Na ion extraction) process is equivalent to a specific charge capacity of about 42 mAh/g. The subsequent discharge process (Na ion insertion) also demonstrates a specific capacity of 42 mAh/g indicating the excellent coulombic (charge) reversibility of this material. The voltage hysteresis between charge and discharge is extremely small, indicating the excellent kinetics of the charge-discharge processes. The symmetrical nature of the differential capacity profile shown in FIG. 2C confirms the excellent charge-discharge reversibility of this material.

### ELECTROCHEMICAL RESULTS FOR THE ACTIVE MATERIAL MADE BY EXAMPLE 3

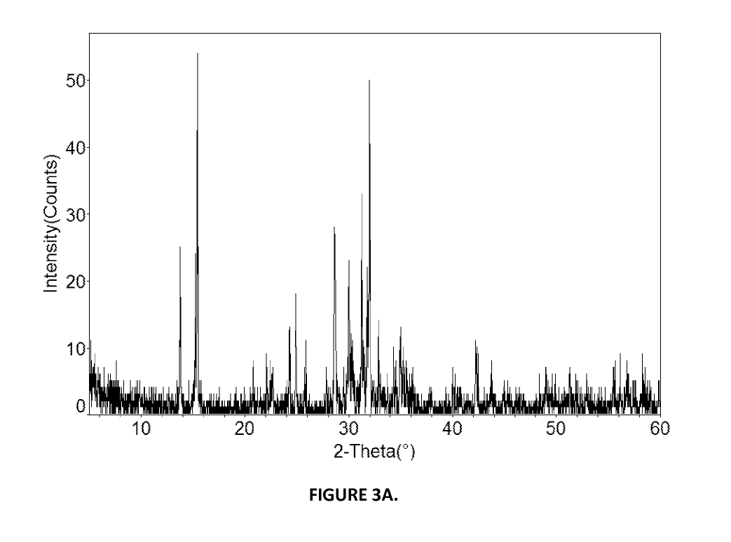

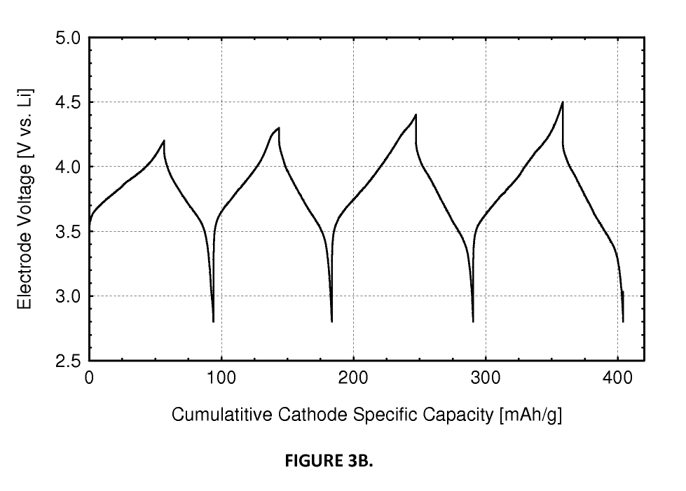

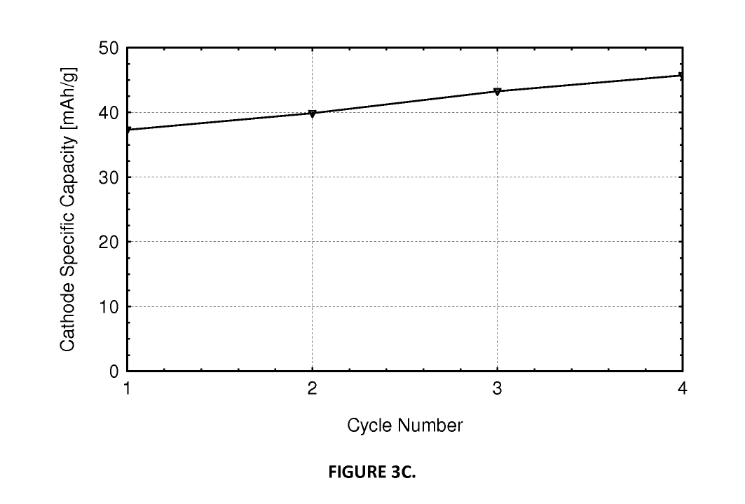

FIG. 3B (Cell #201009) shows the Electrode Potential vs Cumulative Specific Capacity of Na₂Fe(SO₄)₂ (X0182) made by Example 3 in the voltage range 3.0-4.2V vs Li (window opening at 4.5V) in 1M LiPF₆ in EC/DMC. The active material demonstrates a discharge specific capacity of around 46 mAh/g (4^{th} discharge) in the voltage range 3.0-4.5 V vs Li and confirms the charge-discharge reversibility of this material.

FIG. 3C shows the constant current cycling (Discharge Specific Capacity vs Cycle number) of Na₂Fe(SO₄)₂ (X0182) made by Example 3 in the voltage range 3.0-4.2V vs Li (window opening at 4.6V) in 1M LiPF₆ in EC/DMC. Again, the active material demonstrates a discharge specific capacity of around 46 mAh/g (4^{th} discharge) in the voltage range 3.0-4.5 V vs Li.

### ELECTROCHEMICAL RESULTS FOR THE ACTIVE MATERIAL MADE BY EXAMPLE 4

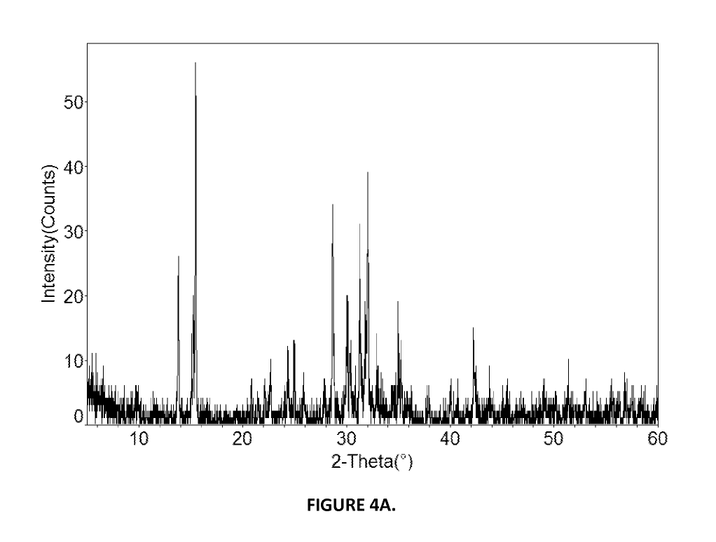

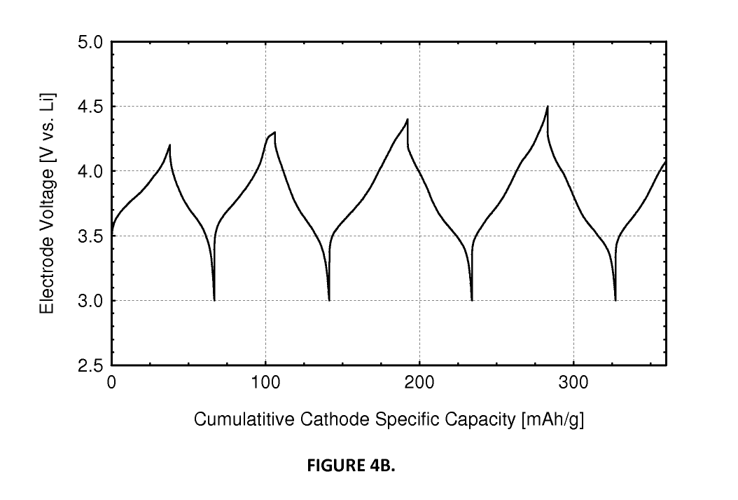

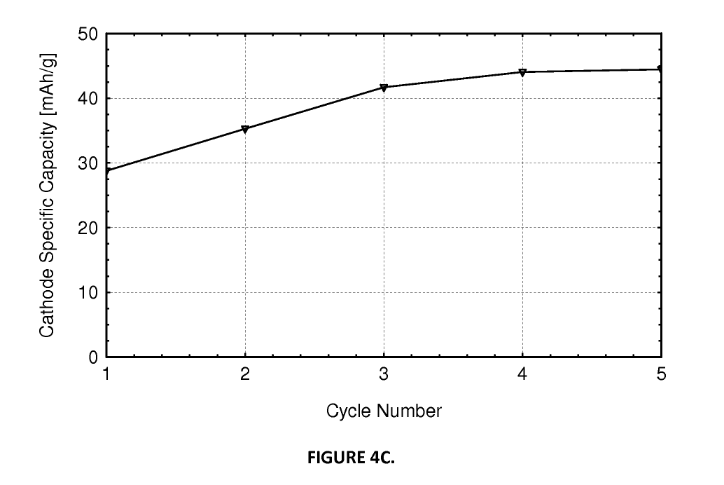

FIG. 4B (Cell #201022) shows the constant current cycling of Na₂Fe(SO₄)₂ (X0224) made by Example 4 (Electrode Potential vs Cumulative Specific Capacity) in the voltage range 3.0-4.2V vs Li (window opening at 4.5V) in 1M LiPF₆ in EC/DMC. The active material demonstrates a discharge specific capacity of around 45 mAh/g (4^{th} discharge) in the voltage range 3.0-4.5 V vs Li and confirms the charge-discharge reversibility of this material.

FIG. 4C shows the constant current cycling (Discharge Specific Capacity vs Cycle number) of Na₂Fe(SO₄)₂ (X0224) made by Example 4 in the voltage range 3.0-4.2V vs Li (window opening at 4.6V) in 1M LiPF₆ in EC/DMC. Again, the active material demonstrates a discharge specific capacity of around 45 mAh/g (4^{th} discharge) in the voltage range 3.0-4.5 V vs Li.

### ELECTROCHEMICAL RESULTS FOR THE ACTIVE MATERIAL MADE BY EXAMPLE 5

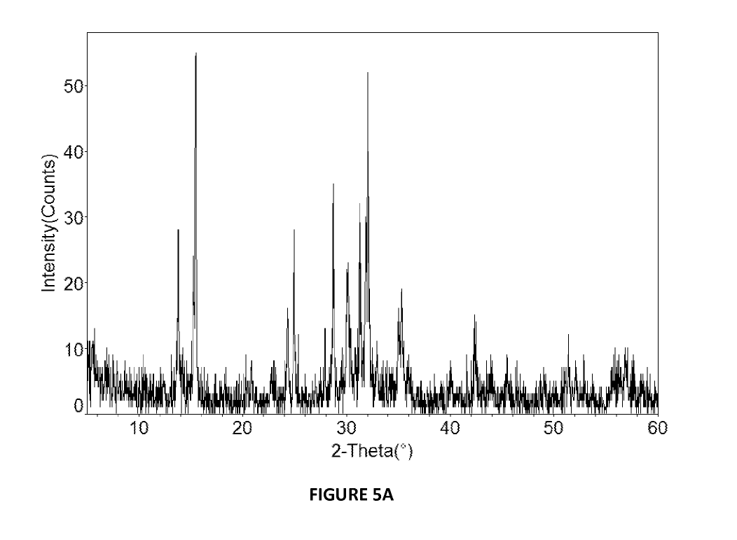

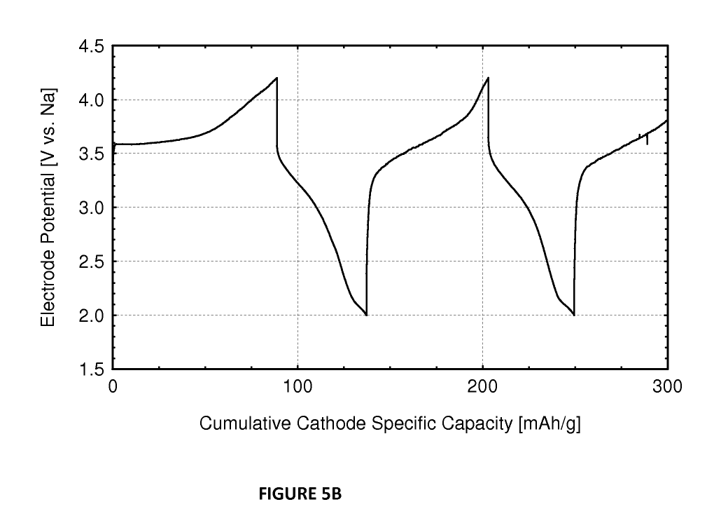

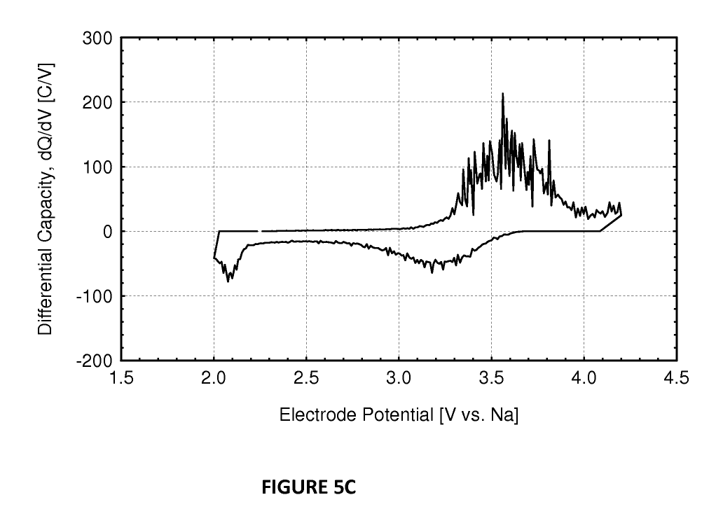

FIGS. 5B and 5C show the Constant current testing of the active material Na₂Fe(SO₄)₂ (X0960) Cell #212012 in the voltage range 2.00-4.20 V vs. Na in an electrolyte of 0.5M NaClO₄ in propylene carbonate. The Open Circuit Voltage (OCV) of the as-made cell was 3.17 V vs. Na. The constant current data were collected using a sodium metal counter electrode at an approximate current density of 0.02 mA/cm² between voltage limits of 2.00 and 4.20 V vs. Na. The testing was carried out at 30° C.

FIG. 5B shows the relationship between electrode potential (V versus a Na reference) and cumulative specific capacity (in mAh/g). FIG. 5C shows the relationship between differential capacity (in C/V) and electrode potential (V versus a Na reference) for the second constant current cycle. During the first charge process an active material specific capacity of 88 mAh/g was achieved while during the first discharge process an active material specific capacity of 49 mAh/g was achieved.

The generally symmetrical nature of the charge-discharge curves indicates the excellent reversibility of the system. The level of voltage hysteresis (i.e. the voltage difference between the charge and discharge processes) is extremely small, indicating the excellent kinetics of the extraction-insertion reactions. This is an important property that is useful for producing a high rate active material. The symmetrical nature of the differential capacity profile further indicates the reversibility of the ion insertion/extraction reactions.

### ELECTROCHEMICAL RESULTS FOR THE ACTIVE MATERIAL MADE BY EXAMPLE 6

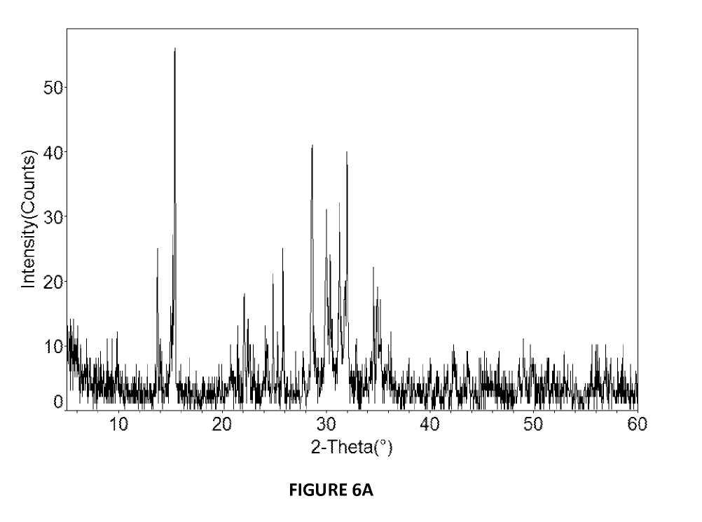

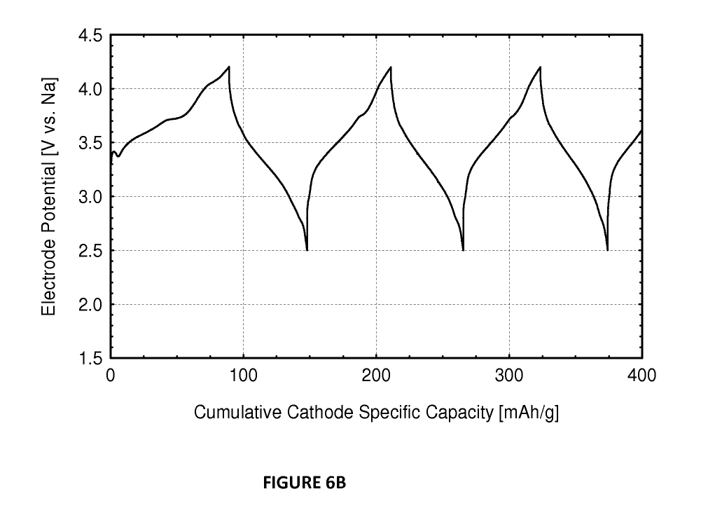

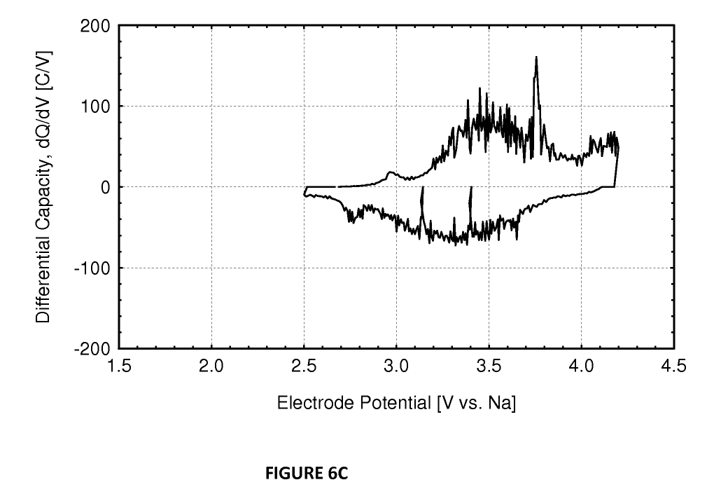

FIGS. 6B and 6C show the Constant current testing of the active material Na₂Fe(SO₄)₂ (X0968) Cell #211083 in the voltage range 2.50-4.20 V vs. Na in an electrolyte of 0.5M NaClO₄ in propylene carbonate. The Open Circuit Voltage (OCV) of the as-made cell was 3.14 V vs. Na. The constant current data were collected using a sodium metal counter electrode at an approximate current density of 0.02 mA/cm² between voltage limits of 2.50 and 4.20 V vs. Na. The testing was carried out at 30° C.

FIG. 6B shows the relationship between electrode potential (V versus a Na reference) and cumulative specific capacity (in mAh/g). FIG. 6C shows the relationship between differential capacity (in C/V) and electrode potential (V versus a Na reference) for the second constant current cycle. During the first charge process an active material specific capacity of 88 mAh/g was achieved while during the first discharge process an active material specific capacity of 60 mAh/g was achieved.

The generally symmetrical nature of the charge-discharge curves indicates the excellent reversibility of the system. The level of voltage hysteresis (i.e. the voltage difference between the charge and discharge processes) is extremely small, indicating the excellent kinetics of the extraction-insertion reactions. This is an important property that is useful for producing a high rate active material. The symmetrical nature of the differential capacity profile further indicates the reversibility of the ion insertion/extraction reactions.

### ELECTROCHEMICAL RESULTS FOR THE ACTIVE MATERIAL MADE BY EXAMPLE 7

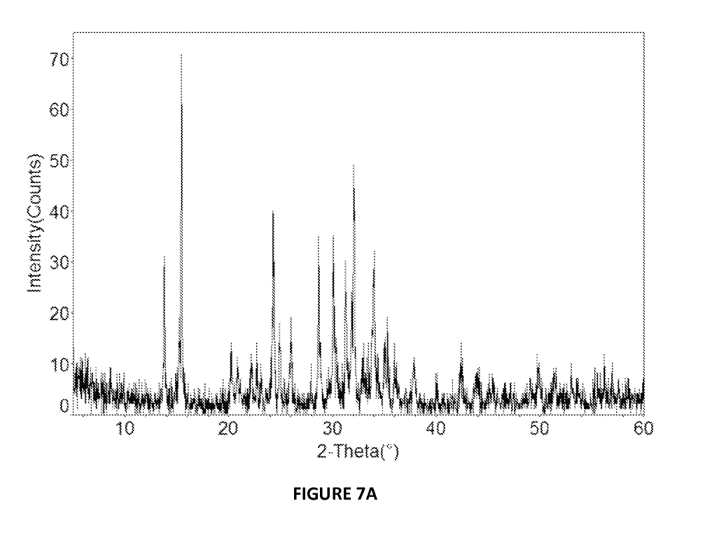

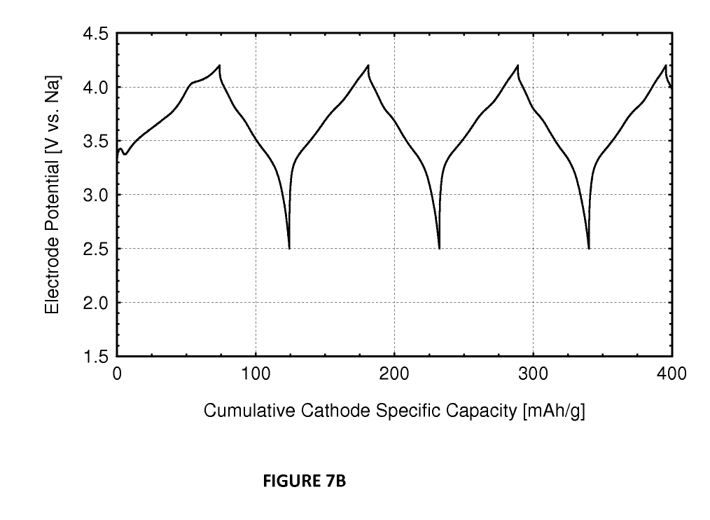

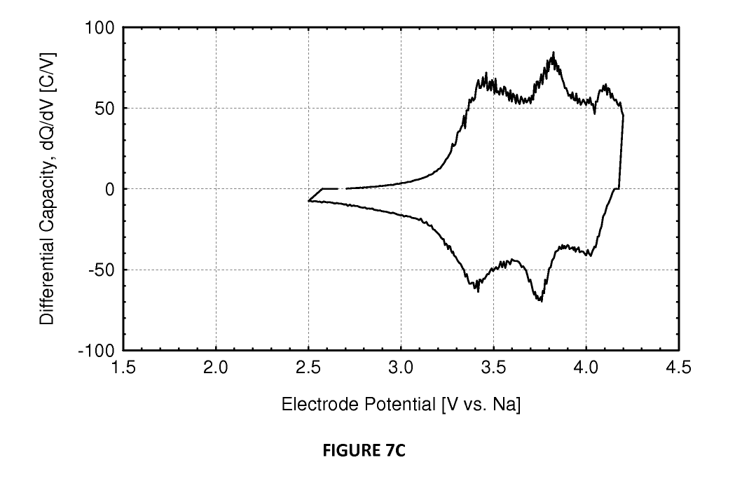

FIGS. 7B and 7C show the Constant current testing of the active material Na₂Fe(SO₄)₂ (X0985) Cell #212012. in the voltage range 2.50-4.20 V vs. Na in an electrolyte of 0.5M NaClO₄ in propylene carbonate. The Open Circuit Voltage (OCV) of the as-made cell was 3.21 V vs. Na. The constant current data were collected using a sodium metal counter electrode at an approximate current density of 0.02 mA/cm² between voltage limits of 2.50 and 4.20 V vs. Na. The testing was carried out at 30° C.

FIG. 7B shows the relationship between electrode potential (V versus a Na reference) and cumulative specific capacity (in mAh/g). FIG. 7C shows the relationship between differential capacity (in C/V) and electrode potential (V versus a Na reference) for the second constant current cycle. During the first charge process an active material specific capacity of 74 mAh/g was achieved while during the first discharge process an active material specific capacity of 51 mAh/g was achieved.

The generally symmetrical nature of the charge-discharge curves indicates the excellent reversibility of the system. The level of voltage hysteresis (i.e. the voltage difference between the charge and discharge processes) is extremely small, indicating the excellent kinetics of the extraction-insertion reactions. This is an important property that is useful for producing a high rate active material. The symmetrical nature of the differential capacity profile further indicates the reversibility of the ion insertion/extraction reactions.

1. An electrode containing an active material of the formula:
AₐM_{b}(SO₄)_{c}Xₓ
wherein
A comprises one or more alkali metals selected from sodium, potassium, sodium mixed with potassium, lithium mixed with sodium, lithium mixed with potassium, and lithium mixed with sodium and potassium;
M is selected from one or more transition metals and/or non-transition metals and/or metalloids;
X is a moiety comprising one or more atoms selected from halogen, O and OH;
and further wherein
a=2; b is in the range: 0<b≦2; c is in the range: 2≦c≦3 and x is in the range 0≦x≦1.

2. An electrode containing an active material according to claim 1 wherein M comprises one or more transition metals and/or non-transition metals and/or metalloids selected from titanium, vanadium, niobium, tantalum, hafnium, chromium, molybdenum, tungsten, manganese, iron, osmium, cobalt, nickel, palladium, platinum, copper, silver, gold, zinc, cadmium, aluminium, scandium, yttrium, zirconium, technetium, rhenium, ruthenium, rhodium, iridium, mercury, gallium, indium, tin, lead, bismuth and selenium, magnesium, calcium, beryllium, strontium, barium, boron, silicon, germanium, arsenic, antimony and tellurium.

3. An electrode containing an active material according to claim 2 wherein M is selected from one or more of nickel, cobalt, manganese and iron.

4. An electrode containing an active material according to claim 1 of the formula: Na₂M(SO₄)₂, where M is selected from one or more of iron and manganese.

5. An electrode containing an active material according to claim 1 of the formula: Na₂M₂(SO₄)₃, where M is selected from one or more of iron and manganese.

6. (canceled)

7. An electrode containing an active material according to claim 1 wherein the molar ratio of a:b:c is 1:1:1.5.

8. An electrode containing an active material according to claim 1 wherein the molar ratio of a:b:c is 1:0.5:1.

9. An electrode according to claim 1 used in conjunction with a counter electrode and one or more electrolyte materials.

10. An electrode according to claim 9 wherein the electrolyte material comprises an aqueous electrolyte material.

11. An electrode according to claim 9 wherein the electrolyte material comprises a non-aqueous electrolyte.

12. An energy storage device comprising an electrode according to claim 1.

13. An energy storage device according to claim 1 suitable for use as one or more of the following: a sodium and/or lithium ion and/or potassium cell, a sodium and/or lithium and/or potassium metal ion cell, a non-aqueous electrolyte sodium and/or lithium and/or potassium ion cell, an aqueous electrolyte sodium and/or lithium and/or potassium ion cell.

14. A rechargeable battery comprising an electrode and/or energy storage device according to claim 1.

15. An electrochemical device comprising an electrode and/or energy storage device according to claim 1.

16. An electrochromic device comprising an electrode and/or energy storage device according to claim 1.
